(19) United States
(12) Patent Application Publication
(10) Pub. No.: US 2022/0103732 A1
(43) Pub. Date: Mar. 31, 2022

(54) IMAGING ASSEMBLY AND CAMERA

(71) Applicant: AAC Optics Solutions Pte. Ltd., Singapore city (SG)

(72) Inventors: Ossi Pirinen, Tampere (FI); Jarno Matikainen, Tampere (FI)

(21) Appl. No.: 17/037,604

(22) Filed: Sep. 29, 2020

(51) Int. Cl. H04N 5/225; G02B 27/10

(52) U.S. Cl. CPC H04N 5/2258; G02B 27/1013

(57) ABSTRACT

Provided is an imaging assembly and a camera. The imaging assembly includes an infrared sensor, a visible light sensor, and a wavelength-selective reflector. The wavelength-selective reflector is configured to reflect the infrared light of the incoming light to the infrared sensor, and transmit the visible light of the incoming light to the visible light sensor. With such a design, the infrared sensor and the visible light sensor can share a part of the optical path to reduce an occurrence possibility of errors between the two, thereby reducing the parallax difference, and optical openings of the imaging assembly can also be reduced. Moreover, since the infrared light and the visible light are from the same incoming light, thereby facilitating matching of a detection result of the infrared sensor and a detection result of the visible light sensor.

### TECHNICAL FIELD

The present invention relates to the technical field of video devices, and more particularly, to an imaging assembly and a camera.

### BACKGROUND

Computational photography and augmented reality (AR) application demand accurate information. Conventionally, a plurality of separate camera units are required for collecting different data. However, in such configuration, different cameras have their individual optical paths, resulting in a parallax difference. Therefore, each camera unit needs to be calibrated for accurate information. If an error occurs between the camera units, it will affect an accuracy of the detected information.

### SUMMARY

The present invention provides an imaging assembly and a camera, aiming to solve the problem that an error easily occurs between the camera units of the camera in the related art.

The present invention provides an imaging assembly, including: an infrared sensor configured to receive infrared light; a visible light sensor configured to receive visible light; and a wavelength-selective reflector configured to reflect infrared light of incoming light to the infrared sensor, and transmit visible light of the incoming light to the visible light sensor.

As an improvement, the wavelength-selective reflector is a reflector mirror or a prism.

As an improvement, an angle is formed between the wavelength-selective reflector and an incoming direction of the incoming light, and the angle is 45°.

As an improvement, the wavelength-selective reflector is a reflector mirror or a prism; an angle is formed between the wavelength-selective reflector and an incoming direction of the incoming light, and the angle is 45°.

As an improvement, the imaging assembly further includes a light guiding component, and the wavelength-selective reflector is provided on the light guiding component.

As an improvement, the infrared sensor is located above the light guiding component along a height direction of the imaging assembly, and the visible light sensor is located at a side of the light guiding component along a length direction of the imaging assembly.

As an improvement, the imaging assembly further includes a lens, configured to make parallel light be converged at a position of the infrared sensor, and configured to make parallel light be converged at a position of the visible light sensor.

As an improvement, the imaging assembly further includes a lens, configured to make parallel light be converged at a position of the infrared sensor, or configured to make parallel light be converged at a position of the visible light sensor.

As an improvement, the imaging assembly further includes a time-of-flight imaging device configured to receive detected information of the infrared sensor.

As an improvement, the imaging assembly further includes a visible light imaging device configured to receive detected information of the visible light sensor.

The present invention further provides a camera, including an imaging assembly, and the imaging assembly includes: an infrared sensor configured to receive infrared light; a visible light sensor configured to receive visible light; and a wavelength-selective reflector configured to reflect infrared light of incoming light to the infrared sensor, and transmit visible light of the incoming light to the visible light sensor.

The present invention provides an imaging assembly and a camera. The imaging assembly includes an infrared sensor, a visible light sensor, and a wavelength-selective reflector. The wavelength-selective reflector is configured to reflect the infrared light of the incoming light to the infrared sensor, and transmit the visible light of the incoming light to the visible light sensor. With such a design, the infrared sensor and the visible light sensor can share a part of the optical path to reduce an occurrence possibility of errors between the two, thereby reducing the parallax difference, and optical openings of the imaging assembly can also be reduced. Moreover, since the infrared light and the visible light are from the same incoming light, thereby facilitating matching of a detection result of the infrared sensor and a detection result of the visible light sensor.

It should be understood that the foregoing general description and the following detailed description are merely exemplary and are not intended to limit the present invention.

### BRIEF DESCRIPTION OF DRAWINGS

FIG. 1 is a schematic structural diagram of an imaging assembly according to an embodiment of the present invention.

### REFERENCE NUMERALS

1—infrared sensor;
2—visible light sensor;
3—wavelength-selective reflector;
4—light guiding component; and
5—lens.

The drawing herein is incorporated into and constitute a part of the present specification, illustrate embodiments of the present invention and explain principles of the present invention together with the specification.

### DESCRIPTION OF EMBODIMENTS

For better illustrating technical solutions of the present invention, embodiments of the present invention will be described in detail as follows with reference to the accompanying drawing.

It should be noted that, the described embodiments are merely exemplary embodiments of the present invention, which shall not be interpreted as providing limitations to the present invention. All other embodiments obtained by those skilled in the art without creative efforts according to the embodiments of the present invention are within the scope of the present invention.

The terms used in the embodiments of the present invention are merely for the purpose of describing particular embodiments but not intended to limit the present invention. Unless otherwise noted in the context, the singular form expressions “a”, “an”, “the” and “said” used in the embodiments and appended claims of the present invention are also intended to represent plural form expressions thereof.

It should be understood that the term “and/or” used herein is merely an association relationship describing associated objects, indicating that there may be three relationships, for example, A and/or B may indicate that three cases, i.e., A existing individually, A and B existing simultaneously, B existing individually. In addition, the character “/” herein generally indicates that the related objects before and after the character “/” form an “or” relationship.

It should be understood that, the terms such as “upper”, “lower”, “left”, “right” and the like are used to indicate positions shown in the drawing, instead of being construed as limitations of the embodiment of the present invention. In addition, when an element is described as being “on” or “under” another element in the context, it should be understood that the element can be directly or via an intermediate element located “on” or “under” another element.

With technology development, camera technology has been continuously updated. Computational photography and augmented reality (AR) application demand accurate information. Conventionally, a camera includes a plurality of separate camera units, and each camera unit has its individual optical path. Different information is collected through these individual camera units. However, when each camera unit has an individual optical path, a parallax difference (i.e., a direction difference when observing a same target from two locations having a certain distance therebetween) will occur. As a result, the parallax difference will affect a final imaging result thereof. Therefore, during usage, each camera unit needs to be calibrated, so as to reduce the parallax difference. In addition, an assembly error easily occurs when assembling these individual camera units, thereby affecting imaging quality. Moreover, different camera units have different optical characteristics, such as sharpness, thereby further increasing difficulty in imaging.

In view of this, an embodiment of the present invention provides an imaging assembly and a camera, aiming to solve the problem that an error easily occurs between the camera units of the camera in the related art.

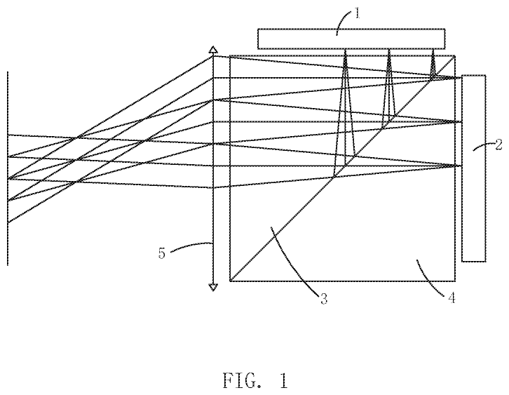

As shown in FIG. 1, an embodiment of the present invention provides an imaging assembly. The imaging assembly includes an infrared sensor 1, a visible light sensor 2, and a wavelength-selective reflector 3. When light reaches the imaging assembly, the wavelength-selective reflector 3 can reflect infrared light of the incoming light to the infrared sensor 1, and transmit visible light of the incoming light to the visible light sensor 2.

When the incoming light reaches the imaging assembly, the visible light and the infrared light of the incoming light can be transmitted in different directions through the wavelength-selective reflector 3, so that different sensors can receive corresponding light. Such a design can allow the infrared sensor 1 and visible light sensor 2 share a part of an optical path of the incoming light, so that the parallax difference can be reduced, thereby improving an accuracy of the collected information and improving the imaging quality. Meanwhile, of the same incoming light, the infrared light is separated from the visible light, thereby reducing optical openings of the imaging assembly, without the need to provide a respective optical opening of the incoming light for an optical path of each of the sensors. In this way, processing steps can be reduced, and processing difficulty can be reduced. Moreover, since all the sensors share the same incoming light and other optical elements, an occurrence possibility of parallax error and distortion can be reduced.

In a possible implementation manner, the imaging assembly further includes a time-of-flight (ToF) imaging device.

The time-of-flight imaging device works in an infrared band, so the time-of-flight imaging device can receive information of the infrared light of the incoming light through the infrared sensor 1, and the time-of-flight imaging device can achieve photography and AR functions. Meanwhile, the time-of-flight imaging device can also be used to measure a distance, a height and a width.

In a possible implementation manner, the imaging assembly further includes a visible light imaging device. The visible light imaging device receives information of the visible light of the incoming light through the visible light sensor 2. For example, the visible light imaging device may be an RGB imaging device, and the RBG represents the colors of three channels of red, green, and blue. Many different colors can be obtained by changing the shades of the three colors of red, green and blue and superimposing the three colors.

The RGB imaging device and the time-of-flight imaging device cooperate to improve the imaging quality, especially when performing AR photography.

In a possible implementation manner, the wavelength-selective reflector 3 is a reflector mirror.

The reflector mirror has advantages such as a simple structure, easily being processed, and being convenient for reflecting the incoming light. For example. in a possible implementation manner, a surface of the reflector mirror is provided with a filter layer, visible light can pass through the filter layer, infrared light cannot pass through the filter layer and is reflected to the infrared sensor 1. It is also possible that the infrared light can pass through the filter layer, while the visible light cannot pass through the filter layer and is reflected to the visible light sensor 2.

The method for separating visible light of incoming light from infrared light of the incoming light by the reflector mirror includes but is not limited to: providing a filter layer in the reflector mirror. Other methods for separating visible light from infrared light may include: changing a material or a microstructure of the reflector mirror to achieve a same technical effect, which will not be repeated herein.

In a possible implementation manner, the reflector mirror is a prism. Such a design can facilitate the wavelength-selective reflector 3 to reflect light to different directions. For example, such a design can reflect infrared light and visible light to different directions, thereby reducing interaction between the infrared light and the visible light, which may affect a detection result of each of the sensors.

Since the imaging assembly provided by the embodiments of the present invention separates the infrared light from the visible light through the wavelength-selective reflector 3 (such as a reflector mirror), an accuracy of separation is high, and light loss is less. Moreover, the infrared light and the visible light are from the same incoming light, thereby facilitating matching of a detection result of the infrared sensor 1 and a detection result of the visible light sensor 2. Therefore, an error thereof can be reduced, and difficulty in imaging can be reduced.

As shown in FIG. 1, in a possible implementation manner, the imaging assembly further includes a light guiding component 4, and the wavelength-selective reflector 3 is installed to the light guiding component 4.

The light guiding component 4 can facilitate installation of the wavelength-selective reflector 3, and can also reduce interference of external factors on the incoming light. The light guiding component 4 may be made of resin or other materials, thereby improving an accuracy of information collected by the imaging assembly, and thus increasing the imaging quality to be more in line with actual usage requirements.

As shown in FIG. 1, in a possible implementation manner, an angle is preset between the wavelength-selective reflector 3 and an incoming direction of the incoming light, and the angle may be 45°.

For example, the visible light can pass through the wavelength-selective reflector 3, and the infrared light can be reflected by the wavelength-selective reflector 3. With such a design, the reflected infrared light can be perpendicular to the visible light. It should be noted that the term “perpendicular” mentioned herein does not represent the meaning of being absolutely perpendicular, but represents the meaning of being approximately perpendicular. Such a design can reduce interference between the visible light and the infrared light, which may affect the detection results of the infrared sensor 1 and the visible light sensor 2, thereby increasing an accuracy of detected information and the imaging quality.

As shown in FIG. 1, in a possible implementation manner, the infrared sensor 1 is located above the light guiding component 4 along a height direction of the imaging assembly, and the visible light sensor 2 is located at a side of the light guiding component 4 along a length direction of the imaging assembly.

With such a design, the infrared sensor 1 and the visible light sensor 2, which is approximately perpendicular to the infrared sensor 1, are provided at different sides of the light guiding component 4, so that an occurrence possibility of interference between positions of the infrared sensor 1 and the visible light sensor 2 can be reduced. Meanwhile, such a design can also reduce an influence of the visible light on the detection result when the infrared sensor 1 receives the infrared light, and an influence of the infrared light on the detection result when the visible light sensor 2 receives the visible light, thereby increasing an accuracy of detected information of the infrared sensor 1 and the visible light sensor 2, and thus increasing the imaging quality.

As shown in FIG. 1, in a possible implementation manner, the imaging assembly further includes a lens 5. The incoming light reaches the light guiding component 4 after being refracted by the lens 5, so that parallel light is converged at a certain positions. The convergent position can be a position where the visible light sensor 2 and/or the infrared light sensor 1 is located.

With such a design, the incoming light can be converged after being refracted by the lens 5, so that the sensor can detect the incoming light.

An embodiment of the present invention further provides a camera, and the camera may include the imaging assembly provided by any embodiment described above. Since the imaging assembly has the technical effects described above, the camera including the imaging assembly also has these technical effects, which will not be repeated herein.

The present invention provides an imaging assembly and a camera. The imaging assembly includes an infrared sensor 1, a visible light sensor 2, and a wavelength-selective reflector 3. The wavelength-selective reflector 3 is configured to reflect the infrared light of the incoming light to the infrared sensor 1, and transmit the visible light of the incoming light to the visible light sensor 2. With such a design, the infrared sensor 1 and the visible light sensor 2 can share a part of the optical path to reduce an occurrence possibility of errors between the two, thereby reducing the parallax difference, and optical openings of the imaging assembly can also be reduced. Moreover, since the infrared light and the visible light are from the same incoming light, thereby facilitating matching of a detection result of the infrared sensor and a detection result of the visible light sensor.

The above-described embodiments are merely preferred embodiments of the present invention and are not intended to limit the present invention. Various changes and modifications can be made to the present invention by those skilled in the art. Any modifications, equivalent substitutions and improvements made within the principle of the present invention shall fall into the protection scope of the present invention.

1. An imaging assembly, comprising:
an infrared sensor configured to receive infrared light;
a visible light sensor configured to receive visible light;
a wavelength-selective reflector configured to reflect infrared light of incoming light to the infrared sensor, and transmit visible light of the incoming light to the visible light sensor; and
a time-of-flight imaging device configured to receive detected information of the infrared sensor.

2. The imaging assembly as described in claim 1, wherein the wavelength-selective reflector is a reflector mirror or a prism.

3. The imaging assembly as described in claim 1, wherein an angle is formed between the wavelength-selective reflector and an incoming direction of the incoming light, and the angle is 45°.

4. The imaging assembly as described in claim 1, wherein the wavelength-selective reflector is a reflector mirror or a prism; and an angle is formed between the wavelength-selective reflector and an incoming direction of the incoming light, and the angle is 45°.

5. The imaging assembly as described in claim 1, further comprising a light guiding component, and the wavelength-selective reflector is provided on the light guiding component.

6. The imaging assembly as described in claim 5, wherein the infrared sensor is located above the light guiding component along a height direction of the imaging assembly, and the visible light sensor is located at a side of the light guiding component along a length direction of the imaging assembly.

7. The imaging assembly as described in claim 1, further comprising a lens, configured to make parallel light be converged at a position of the infrared sensor, and configured to make parallel light be converged at a position of the visible light sensor.

8. The imaging assembly as described in claim 1, further comprising a lens, configured to make parallel light be converged at a position of the infrared sensor, or configured to make parallel light be converged at a position of the visible light sensor.

9. (canceled)

10. The imaging assembly as described in claim 1, further comprising a visible light imaging device configured to receive detected information of the visible light sensor.

11. A camera, comprising an imaging assembly, wherein the imaging assembly comprises:
an infrared sensor configured to receive infrared light;
a visible light sensor configured to receive visible light; and
a wavelength-selective reflector configured to reflect infrared light of incoming light to the infrared sensor, and transmit visible light of the incoming light to the visible light sensor.
